(19) United States
(12) Patent Application Publication
(10) Pub. No.: US 2003/0165234 A1
(43) Pub. Date: Sep. 4, 2003

(54) Device having a voice communication server structure and comprising a digital signal processor

(75) Inventors: Patrick Mourot, Illkirch (FR); Alain Blanc, Illkirch-Graffenstaden (FR)

Correspondence Address: SUGHRUE MION, PLLC, 2100 Pennsylvania Avenue, Washington, DC, 20037-3213, US

(73) Assignee: ALCATEL

(21) Appl. No.: 10/086,425

(22) Filed: Mar. 4, 2002

(51) Int. Cl. H04M 1/00; H04M 9/00

(52) U.S. Cl. 379/413.02

(57) ABSTRACT

The present invention proposes a device having a voice communication server structure comprising a rack called main rack including:

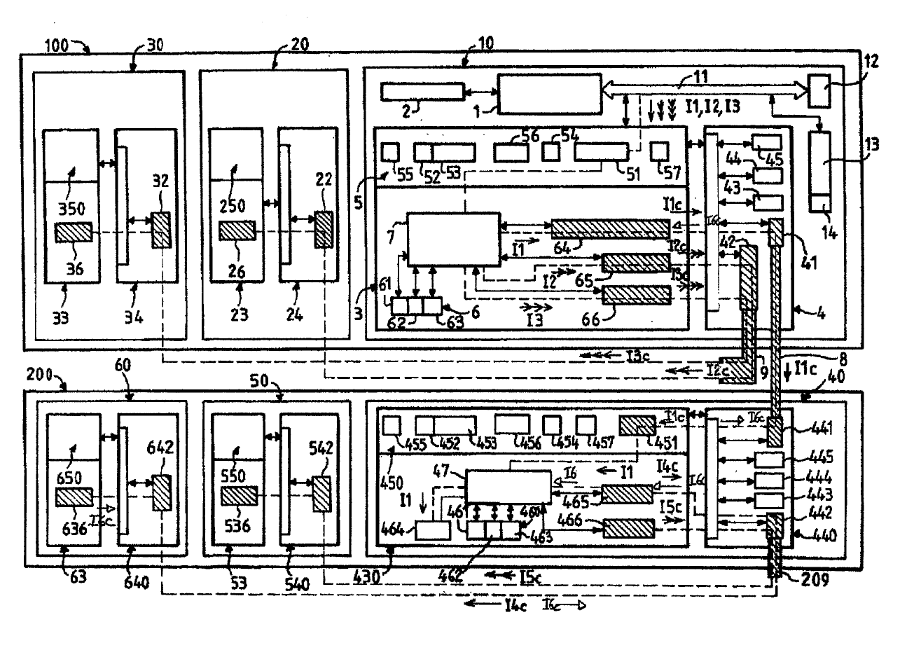

a board called master board equipped with:

a Central Processing Unit (CPU),

a Digital Signal Processor (DSP) called master DSP for a telephonic application running on said master board, and having an access to a switching unit,

a second DSP, distinct from said master DSP, for a telecommunication application and having an access to a switching unit,

inter-DSP communication means arranged to allow in real time a direct exchange of information between said master and second DSP.

### TECHNICAL FIELD

The invention relates to telecommunication devices. More particularly, it relates to a device having a voice communication server structure and comprising a Digital Signal Processor (DSP).

### BACKGROUND OF THE INVENTION

As is known, a Voice Communication Server such as a Private Branch exchange (PBX) comprises a main rack comprising a master board generally equipped with:

a Central Processing Unit (CPU),

memories mastered by the CPU,

a DSP for a telephonic application ensuring by way of example, switching, Dual Tone MultiFrequency (DTMF) detection, generation, play and record, and Analog Serial Link (ASL) management,

a switching unit,

access to external transmission links such as Pulse Coded Modulation (PCM) link and ASL.

Future generations of PBX can further comprise at least an additional DSP for a telecommunication application comprising accesses to the switching unit.

### SUMMARY OF THE INVENTION

An object of the invention is to make it possible to exchange information between two DSPs when needed.

For this purpose, the present invention provides a device having a voice communication server structure comprising a rack called main rack including:

a board called master board equipped with:

a Central Processing Unit (CPU),

a Digital Signal Processor (DSP) called master DSP for a telephonic application running on said master board, and having an access to a switching unit,

a second DSP, distinct from said master DSP, for a telecommunication application, and having an access to a switching unit,

inter-DSP communication means arranged to allow in real time a direct exchange of information between said master and second DSP.

Inter-DSP communication means of the invention are conceived to offer transparency, reliability and flexibility. Inter-DSP communication means of the invention run under hard time constraints. Therefore, each exchange of information between DSPs is performed during a real time window e.g. of 125 μs avoiding the risk of causing errors. Moreover, Inter-DSP communication means are low CPU consuming means.

By way of example, the information exchange can be High Level Data Link data, tones generation or detection.

The switch units of the invention can be Application Specific Integrated Circuit (ASIC).

Advantageously, the master DSP and the second DSP of the invention can comprise

several resources chosen among one or more of the following: Analog Serial Link (ASL) resources, High Level Data Link (HDLC) resources, On Board Controller (OBC) resources,

an operating system including:

internal memories mastered by memory management means,

means managing the access to the switching unit,

resource management means arranged to select one of the resources,

a scheduler included in said operating system and arranged to execute said selected resource.

As internal memories can be small, inter-DSP communication means fit in small internal memory footprint.

Memory management means manage memories dynamically.

A resource of the invention is a real time software dynamically reconfigurable. More precisely, a resource is a program containing codes and data. Such a program is static when it is not running and becomes a dynamic process with an execution context when selected. When the resource is activated parameters are given to the resource and a context containing execution data is also allocated. Each resource is indexed according to a type, e.g. detector or generator, and is activated depending on its type. When a resource stops, this resource can be deactivated, setting free the context. A resource may also have a procedure entry point allowing operations on deactivation (e.g. dynamic memory release . . . ). Several resources can run same codes but with different data.

A resource can be downloaded and unloaded on request and on the fly. When a resource is unloaded the code is no longer available. The operating system of the invention allows quick insertion and management of new resources: only few information are needed for the user to take into account new resources.

Resource management means are in charge of activating/deactivating, downloading/unloading, debuging/tracing all types of resources.

The scheduler of the invention executes the selected resource at the right timing in the right order according to its priority. When a resource exceeds a given quantum then the scheduling starts again with the highest priority resource. The rules governing the structure of resources are simple and well defined. On each DSP of the invention the resource use is easy, consumes low memory and provides quick signal processing.

The master DSP contains information directed to the second DSP and/or vice versa.

In one embodiment of the invention, the inter-DSP communication means comprise an information coding resource included in the master DSP and/or in the second DSP and coding the information to be exchanged, the coded information being a frame containing control information, data and checksum.

By way of example, control information are the first byte of the frame. Data are the relevant bytes of the frame. Cheksum is the last byte of the frame; it is used to control the correct reception of the whole frame since it is the sum of all the data of the frame.

Each frame can be acknowledged. If no acknowledgement is received during a given period of time, the frame is considered as lost and it is re-transmitted.

An information coding resource is a program instantiated for each link to be handled i.e. it is involved in inter-DSP communications.

More broadly, a master DSP emitting several information for several DSPs contains one information coding resource per DSP to be in contact with.

In this embodiment of the invention, the inter-DSP communication means can comprise an inter-DSP resource included in the second DSP and/or in the master DSP and arranged to receive (and namely decode) the coded information, coded by an information coding resource.

Of course, an information coding resource of an emitter DSP can also play the role of an inter-DSP resource when the latter becomes a receiver DSP. Identically, an inter-DSP resource of a receiver DSP can play the role of an information coding resource when the latter becomes an emitter DSP.

Preferably, the second DSP of the invention can run on a second board distinct from the master board and thus the inter-DSP communication means can comprise a link allowing full duplex information exchanges and connecting the master board and the second board together.

Such a link is itself connected to the switching units of the invention which have accesses to the master DSP and to the second DSP.

In a first embodiment of the invention, the second board is an applicative board included in the main rack and the link of the invention is a synchronous link and preferably a Pulse Coded Modulation (PCM) link.

A PCM link, generally digitally transmitting information such as analog voice signal, can convey 8 bits data which are called time slots since they are the subdivisions of time of a complete frame. The PCM procedure is seen by the DSPs of the invention as a memory refreshed for example each 125 μs. Each PCM has 32 timeslots and all of them are consecutive.

Such a link allows a transparent, error free transmission of the information.

In this first embodiment of the invention, the telecommunication application of the second DSP can be an Internet Protocol (IP) application preferably chosen among Internet Access and Voice over IP.

Besides, the master DSP and the second DSP can comprise communication management means respectively having access to memories of the master board and of the applicative board.

In a second embodiment of the invention, the second board is an expansion board included in an expansion rack in slave mode with respect to the main rack and the link connecting the master board and the expansion board together can be a synchronous link and can be preferably an High Speed Link (HSL).

An expansion rack of the invention allows an increased number of subscribers.

By way of example, such an HSL link which is the physical layout conveying exchanged information can provide:

8 PCM full duplex multiplexed on a single pair,

clock recovery and frame alignment on each reception side,

message channel for downloading, remote, reset or others.

HSL dimensioning can be 256 timeslots which are managed for example every 125 μs by the switching units of the invention.

Furthermore, the second DSP can emit and/or receive coded information.

Thus, in this second embodiment, the inter-DSP communication means comprise preferably communication management means included in the second DSP and arranged to decode the coded information and/or to code information to be exchanged.

Thus, in the first configuration of information exchange in which the second DSP is a receiver DSP, communication management means distribute the coded information inside the second DSP and in the second configuration in which the second DSP is an emitter DSP, to send the coded information outside the second DSP.

The present invention also proposes a device having a voice communication server structure comprising an expansion rack without CPU and including

an expansion board equipped with a slave DSP for a telephonic application running on said expansion board, said slave DSP having an access to a switching unit,

an expansion applicative board distinct from said expansion board equipped with an applicative slave DSP for a telecommunication application which is not a telephonic application, running on said expansion applicative board, said applicative slave DSP having an access to a switching unit,

whereby it comprises inter-DSP communication means arranged to allow in real time a direct exchange of information between at least said slave DSP and said applicative slave DSP.

In this latter device, the inter-DSP communication means can comprise:

a link allowing full duplex information exchanges and connecting the expansion board and the expansion applicative board together.

Moreover, the applicative slave DSP and the slave DSP can comprise:

several resources chosen among one or more of the following: ASL resources, HDLC resources and OBC resources,

an operating system including:

internal memories mastered by memory management means,

means managing the access to a switch unit,

resource management means arranged to select one of the resources,

a scheduler included in the operating system and arranged to execute the selected resource.

In one embodiment of the invention the inter-DSP communication means comprise:

an information coding resource included in the slave DSP and/or the applicative slave DSP and coding the information to be exchanged, the coded information being a frame containing control information, data and checksum,

an inter-DSP resource included in the applicative slave DSP and/or the slave DSP and arranged to receive the coded information.

More broadly, a DSP emitting several information for several DSPs contains one information coding resource per DSP to be in contact with.

Advantageously, the telecommunication application supported by the applicative slave DSP can be an Internet Protocol (IP) application preferably chosen among Internet Access and Voice over IP.

### BRIEF DESCRIPTION OF THE DRAWINGS

Other characteristics and advantages of the invention will appear on reading the following description of a preferred embodiment of the invention, given by way of example and with reference to the accompanying drawing, in which the FIGURE is a diagrammatic representation of a device having a private branch exchange structure in a preferred embodiment of the invention.

### BEST MODE FOR CARRYING OUT THE INVENTION

This device has a voice communication server structure comprising:

a rack called main rack 100, including a board called master board 10 and two others boards called applicative boards 20, 30,

a rack called expansion rack 200 in slave mode with respect to the main rack 100, including a board called slave board 40 and two other boards called applicative slave boards 50, 60.

The master board 10 is equipped with:

a Central Processing Unit (CPU) 1 with memories 2,

a Digital Signal Processor (DSP) called master DSP 3 for a telephonic application running on the master board 10, having an access to a switching unit such as an Application Specific Integrated Circuit (ASIC) 4 containing a PCM multiplexer/demultiplexer 41, a switch 42, High Level Data Link (HDLC) means 43, ADPCM (Adaptative Delta Pulse Coded Modulation) means 44, and DUART means (Double Universal Asynchronous Receiver Transmitter) 45 for Analog Serial Link (ASL) access.

The PCM multiplexer/demultiplexer 41 is connected to an HSL fink 8 connecting this master board 10 and the slave board 40. The switch 42 is connected to a PCM link 9 (partially shown) connecting the master board 10 and the applicative boards 20, 30.

In addition, the master board 10 comprises:

a Peripherical Component Interconnect (PCI) bus 11, giving accesses to the CPU 1 and an Ethernet controller 12,

a specific DSP 13 with external memory 14 for modem running,

The DSP 13 is not involved in the inter-DSP exchange of information according to the invention.

The master DSP 3 comprises:

an operating system (OS) 5 including:

communication management means 51 having access to memories 2 namely via the PCI bus 11,

internal memories 52 mastered by memory management means 53,

message management means 54 allowing communication between different means of the master DSP 3,

a library 55 of functions used by different means of the master DSP 31

means 57 managing the access to the switching unit 4,

several resources 6 such as ASL resources 61, HDLC resources 62, OBC (On Board Controller) resources 63 and three information coding resources such as an HSL controlling resource 64 and PCM controlling resources 65, 66, for example the resources 65, 66 coding information to transmit to the applicative DSPs 23, 33 of applicative boards 20, 30, the information coding resource 64 is also an inter-DSP resource, arranged to receive and decode coded information from a slave DSP 430,

resource management means 7 arranged to select one of the resources 6 to be activated,

a scheduler 56 included in the OS 5 arranged to execute the selected resource.

The applicative boards 20, 30 comprise the applicative DSP 23, 33 respectively for Internet Access and Voice over IP. These DSP 23, 33 include similar means (not shown) to the master DSP 33 and namely an inter-DSP resource 26, 36 arranged to receive the coded information coming from the master DSP 3.

The applicative boards 20, 30 also comprise similar means (not shown) around their applicative DSP 23, 33. The main difference is that their ASIC 24, 34 comprises a switch 22, 32 but does not comprise a PCM multiplexer/demultiplexer connected to a HSL link.

Besides, the slave board 40 is equipped with:

a DSP called slave DSP 430 for a telephonic application running on the slave board 40,

a switching unit such as an ASIC 440 containing a PCM multiplexer/demultiplexer 441, and a switch 442, HDLC means 443, ADPCM means 444 and DUART means 445 for ASL access.

The PCM multiplexer/demultiplexer 441 is connected to the HSL link8. The switch 442 is connected to a PCM link 209 (partially shown) connecting the master board 10 and the slave applicative board 50, 60.

The slave DSP 430 comprises:

an OS 450 including:

communication management means 451 arranged to decode the coded information coming from the master DSP 3 and to distribute the latter inside the slave DSP 430, and to code information coming from the slave DSP 430 and to transmit the latter to the master DSP 3,

internal memories 452 mastered by memory management means 453,

message management means 454 allowing communication between different means of the slave DSP 43,

a library 455 of functions used by different means of the slave DSP 430,

means 457 managing the access of the slave DSP 430 to the switching unit 440,

several resources 460 such as ASL resources 461, 464 HDLC resources 462, OBC resources 463, two information coding resources such as PCM controlling resources 465, 466 coding information to transmit to the applicative slave DSP 53, 63, the information coding resource 465 is also an inter-DSP resource, arranged to receive and decode coded information from applicative slave DSPs 53, 63,

resource management means 47 arranged to select one of the resources 460 to be activated,

a scheduler 456 included in the OS 450 arranged to execute the selected resource.

Applicative slave boards 50, 60 comprise the applicative slave DSP 53, 63 respectively for Internet Access and Voice over IP. These DSP 53, 63 include similar means than the slave DSP 430 such as an operation system 550, 650, and an inter-DSP resource 536, 636 arranged to receive and decode the coded information coming from the slave DSP 430. The inter-DSP resource 636 is also an information coding resource arranged to code information directed to the slave DSP 430.

The applicative boards 50, 60 also comprise similar means (not shown) around their applicative slave DSP 53, 63. The main difference is that their ASIC 540, 640 comprises a switch 542, 642 and does not comprise a PCM multiplexer/demultiplexer connected to a HSL link.

Inter-DSP communication means of the invention are arranged to allow in real time a direct exchange of information between the master DSP 3 and the slave DSP 430 or the applicative DSP 23, 33 or between the slave DSP 430 and the applicative slave DSP 53, 63. Inter-DSP communication means comprise the elements already described which are represented in the FIGURE with hatchures.

Information exchanged is coded so that it is a frame containing control information, data and checksum. Several information can be transmit in a buffer. It allows operations of debugging, error free mode and acknowledgment management and permit to check if the receiver DSP is still working.

By way of example, the FIGURE shows (see dotted lines) the path of coded information exchanged between different DSPs:

I1c is transmitted from the master DSP 3 to the slave DSP 430; I1c contains namely data of information I1 transmitted through the PCI bus 11 and I1c is decoded by means 451 becoming again I1,

I2c is transmitted from the master DSP 3 to the applicative DSP 23; I2c contains namely data of information I2 transmitted through the PCI bus 11,

I3c is transmitted from the master DSP 3 to the applicative DSP 33; I3c contains namely data of information 13 transmitted through the PCI bus 11,

I4c is transmitted from the slave DSP 430 to the applicative slave DSP 53,

and I5c is transmitted from the slave DSP 430 to the applicative slave DSP 63.

The applicative DSP 23, 33 or the slave DSP 430 can also transmit information to the master DSP 3. Similarly, the applicative slave DSP 53, 63 can also transmit information to the slave DSP 430. By way of example, coded information I6c is transmitted from the applicative slave DSP 63 to the slave DSP 430, decoded by the resource 465, becoming an information I6, and coded by means 451, becoming again coded information 16c transmitted to the master DSP 3.

In an alternative embodiment of the device 200, a device (not shown) can only include an expansion rack similar to the expansion rack 200.

Naturally, the present invention is not limited to the example and embodiment described and shown, and the invention can be the subject of numerous alternatives that are available to the person skilled in the art.

The device of the invention can also include several expansion racks as well as other kinds of boards.

1. Device having a voice communication server structure comprising a rack called main rack including:
a board called master board equipped with:
a Central Processing Unit (CPU),
a Digital Signal Processor (DSP) called master DSP for a telephonic application running on said master board, and having an access to a switching unit,
a second DSP, distinct from said master DSP, for a telecommunication application and having an access to a switching unit,
inter-DSP communication means arranged to allow in real time a direct exchange of information between said master and second DSP.

2. Device in accordance with claim 1 whereby said master DSP and said second DSP comprise:
several resources chosen among one or more of the following: Analog serial link (ASL) resources, High Level Data Link (HDLC) resources and On Board Controller (OBC) resources,
an operating system including:
internal memories mastered by memory management means,
means managing said access to a switching unit,
resource management means arranged to select one of said resources,
a scheduler included in said operating system and arranged to execute said selected resource.

3. Device in accordance with any of claims 1 or 2 whereby said inter-DSP communication means comprise an information coding resource included in said master DSP and/or in said second DSP and coding said information to be exchanged, said coded information being a frame containing control information, data and checksum.

4. Device in accordance with claim 3 whereby said inter-DSP communication means comprise an inter-DSP resource included in said second DSP and/or in said master DSP and arranged to receive coded information.

5. Device in accordance with any of claims 3 or 4 whereby said second DSP runs on a second board distinct from said master board and in that said inter-DSP communication means comprise a link allowing full duplex information exchanges and connecting said master board and said second board together.

6. Device in accordance with claim 5 whereby said second board is an applicative board included in said main rack, and said link is a synchronous link and is preferably a Pulse Coded Modulation (PCM) link.

7. Device in accordance with claim 6 whereby said telecommunication application of said second DSP is an Internet Protocol (IP) application preferably chosen among Internet Access and Voice over IP.

8. Device in accordance with any of claims 6 or 7 whereby said master DSP and said second DSP comprise communication management means respectively having access to memories of said master board and of said applicative board.

9. Device in accordance with claim 5 whereby said second board is an expansion board included in an expansion rack in slave mode with respect to said main rack, and said link is a synchronous link and is preferably an High Speed Link (HSL).

10. Device in accordance with claim 9 whereby said inter-DSP communication means comprise communication management means included in said second DSP and arranged to decode said coded information and/or to code information to be exchanged.

11. Device having a voice communication server structure comprising an expansion rack without CPU and including:
an expansion board equipped with a slave DSP for a telephonic application running on said expansion board, said slave DSP having an access to a switching unit,
an expansion applicative board distinct from said expansion board equipped with an applicative slave DSP for a telecommunication application which is not a telephonic application, running on said expansion applicative board, said applicative slave DSP having an access to a switching unit,
whereby it comprises inter-DSP communication means arranged to allow in real time a direct exchange of information between at least said slave DSP and said applicative slave DSP.

12. Device in accordance with claim 11 whereby said inter-DSP communication means comprise
a link allowing full duplex information exchanges and connecting said expansion board and said expansion applicative board together.

13. Device in accordance with any of claims 11 or 12 whereby said applicative slave DSP and said slave DSP comprise:
several resources chosen among one or more of the following: ASL resources, HDLC resources and OBC resources,
an operating system including:
internal memories mastered by memory management means,
means managing said access to a switching unit,
resource management means arranged to select one of said resources,
a scheduler included in said operating system and arranged to execute said selected resource.

14. Device in accordance with any of claims 11 to 13 whereby said inter-DSP communication means comprise:
an information coding resource included in said slave DSP and/or said applicative slave DSP and coding said information to be exchanged, said coded information being a frame containing control information, data and checksum,
an inter-DSP resource included in said applicative slave DSP and/or said slave DSP and arranged to receive said coded information.

15. Device in accordance with any of claims 11 to 14 whereby said telecommunication application is an Internet Protocol (IP) application preferably chosen among Internet Access and Voice over IP.
